(19) United States
(12) Patent Application Publication
(10) Pub. No.: US 2015/0220331 A1
(43) Pub. Date: Aug. 6, 2015

(54) RESOLVING MERGE CONFLICTS THAT PREVENT BLOCKS OF PROGRAM CODE FROM PROPERLY BEING MERGED

(71) Applicant: International Business Machines Corporation, Armonk, NY (US)

(72) Inventors: Howard B. Bernstein, Lexington, MA (US); Sujeet Mishra, Bangalore (IN); Rohit Shetty, Bangalore (IN)

(73) Assignee: International Business Machines Corporation, Armonk, NY (US)

(21) Appl. No.: 14/173,167

(22) Filed: Feb. 5, 2014

(51) Int. Cl. G06F 9/44; G06F 17/30

(52) U.S. Cl. CPC G06F 8/71; G06F 17/30598

(57) ABSTRACT

This disclosure relates to resolving merge conflicts that prevent blocks of program code from properly being merged. A merge conflict that prevents blocks of program code from properly being merged can be identified. Responsive to identifying the merge conflict, a pattern of a respective portion of at least one of the blocks of program code can be identified, and a determination can be made as to whether the pattern matches an existing merge rule. Responsive to determining that the pattern matches the existing merge rule, the existing merge rule can be validated against a syntax of the portion of at least one of the blocks of program code. Responsive to the existing merge rule successfully validating against the syntax of the portion of at least one of the blocks of program code, the existing merge rule can be applied to resolve the merge conflict.

### BACKGROUND

This disclosure relates to resolving merge conflicts that prevent blocks of program code from properly being merged.

To facilitate rapid software development, software development companies oftentimes use globally distributed development teams which that on software development projects in parallel. One of the challenges of parallel development is integration, which requires merging of separately developed blocks of program code. Software configuration management systems typically are used to facilitate this task. While software configuration management systems sometimes provide means for resolving trivial merge scenarios automatically, manual intervention on the part of one or more developers oftentimes is required.

### SUMMARY

A method includes identifying at least a first merge conflict that prevents a plurality of blocks of program code from properly being merged. The method also includes, responsive to identifying the first merge conflict, using a processor, identifying a first pattern of a respective portion of at least one of the blocks of program code that cause the first merge conflict and determining whether the first pattern matches at least a first existing merge rule. The method also includes, responsive to determining that the first pattern matches the first existing merge rule, validating the first existing merge rule against a syntax of the portion of at least one of the blocks of program code that cause the first merge conflict. The method also includes, responsive to the first existing merge rule successfully validating against the syntax of the portion of at least one of the blocks of program code that cause the first merge conflict, applying the first existing merge rule to resolve the first merge conflict.

A system includes a processor programmed to initiate executable operations. The executable operations include identifying at least a first merge conflict that prevents a plurality of blocks of program code from properly being merged. The executable operations include, responsive to identifying the first merge conflict, identifying a first pattern of a respective portion of at least one of the blocks of program code that cause the first merge conflict and determining whether the first pattern matches at least a first existing merge rule. The executable operations also include, responsive to determining that the first pattern matches the first existing merge rule, validating the first existing merge rule against a syntax of the portion of at least one of the blocks of program code that cause the first merge conflict. The executable operations also include, responsive to the first existing merge rule successfully validating against the syntax of the portion of at least one of the blocks of program code that cause the first merge conflict, applying the first existing merge rule to resolve the first merge conflict.

A computer program includes a computer readable storage medium having program code stored thereon. The program code is executable by a processor to perform a method. The method includes identifying, using the processor, at least a first merge conflict that prevents a plurality of blocks of program code from properly being merged. The method also includes, responsive to identifying the first merge conflict, identifying, using the processor, a first pattern of a respective portion of at least one of the blocks of program code that cause the first merge conflict and determining whether the first pattern matches at least a first existing merge rule. The method also includes, responsive to determining that the first pattern matches the first existing merge rule, validating, using the processor, the first existing merge rule against a syntax of the portion of at least one of the blocks of program code that cause the first merge conflict. The method also includes, responsive to the first existing merge rule successfully validating against the syntax of the portion of at least one of the blocks of program code that cause the first merge conflict, applying, using the processor, the first existing merge rule to resolve the first merge conflict.

### BRIEF DESCRIPTION OF THE SEVERAL VIEWS OF THE DRAWINGS

FIG. 1 is a block diagram illustrating an example of a network computing system.

FIG. 2 is a flow chart illustrating an example of a method of resolving merge conflicts arising from merging program code.

FIG. 3 is a flow chart illustrating an example of a method of generating a new merge rule.

FIG. 4 is a flow chart illustrating a further example of a method of generating a new merge rule.

FIG. 5 is a block diagram illustrating example architecture for a data processing system.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to resolving merge conflicts that prevent a plurality of blocks of program code from properly being merged. In accordance with the inventive arrangements disclosed herein, one or more merge conflicts that prevent a plurality of blocks of program code from properly merging can be identified. In response, each merge conflict can be categorized. Further, a respective portion of at least one of the blocks of program code that cause a merge conflict can be identified, and a determination can be made as to whether this pattern matches at least one existing merge rule. If the pattern does not match an existing merge rule, the merge conflict can be identified as needing to be resolved manually. If the pattern matches an existing merge rule, the existing merge rule can be validated against syntax of the portion of program code that causes the merge conflict. If the existing merge rule is successfully validated against the syntax of the program code that causes the merge conflict, the existing merge rule can be applied to resolve the merge conflict. If the existing merge rule is not successfully validated against the syntax of the program code that causes the merge conflict, the merge conflict can be identified as needing to be resolved manually.

If a merge conflict is resolved manually, the manner in which the merge conflict is manually resolved can be analyzed. Based on this analysis, a new rule can be automatically generated and categorized for use in resolving further merge conflicts that may occur. In addition, each time a merge rule is applied to resolve a merge conflict, parameters related to a weight and/or relevance of the merge rule can be generated and/or updated.

Several definitions that apply throughout this document now will be presented.

As defined herein, the term “block” means a group of a plurality of lines of program code. These lines of program code can be contained in a file, a module, or the like.

As defined herein, the term “merge conflict” means a conflict that prevents a plurality of blocks of program code from properly being merged.

As defined herein, the term “inference” means information, inferred from a change to program code to resolve a merge conflict, which indicates a possible manner in which other program code may be changed to resolve a similar merge conflict.

As defined herein, the term “merge rule” means a structured data configured to resolve a merge conflict.

As defined herein, the term “semantic construct” means one or more lines of program code that convey a meaning. In this regard, program code not only may include instructions to be executed by a processor, but also may include text, comments, etc.

As defined herein, the term “computer readable storage medium” means a storage medium that contains or stores program code for use by or in connection with an instruction execution system, apparatus, or device. As defined herein, a “computer readable storage medium” is not a transitory propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), an application specific integrated circuit (ASIC) and a controller.

As defined herein, the term “server” means a data processing system comprising at least one processor.

As defined herein, the term “client device” means a data processing system comprising at least one processor via which a user interacts with a computing system.

As defined herein, the term “automatically” means without user intervention.

As defined herein, the term “user” means a person (i.e., a human being).

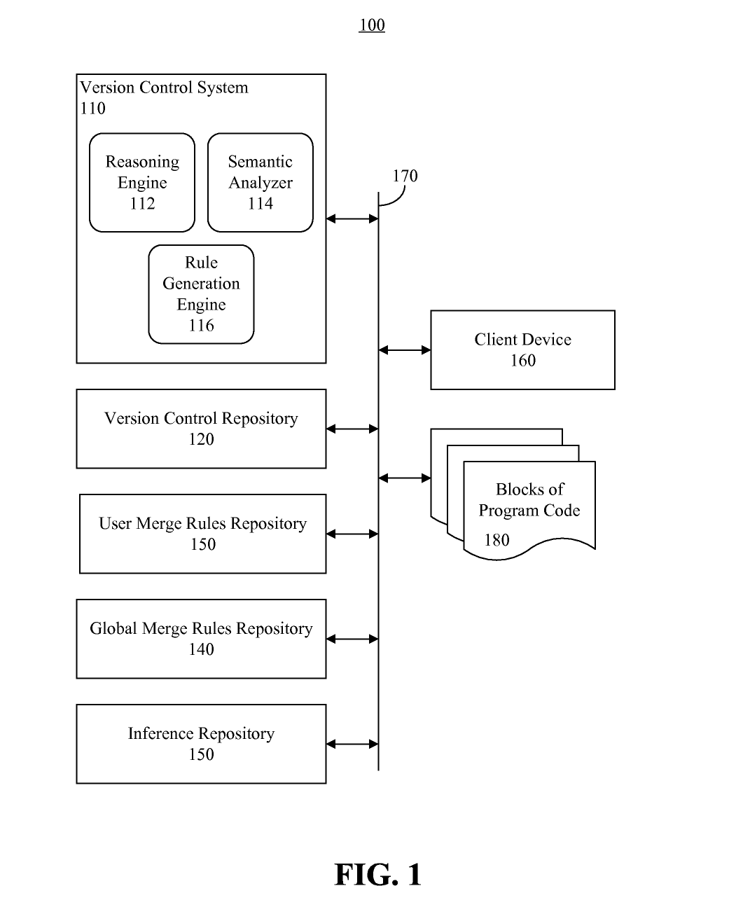

FIG. 1 is a block diagram illustrating an example of a computing system (hereinafter “system”) 100. The system 100 can include a version control system 110, a version control repository 120, a user merge rules repository 130, a global merge rules repository 140, an inference repository 150 and a client device 160.

The version control system 110 can be implemented using suitable program code executed by at least one processor. The version control system 110 can include, or otherwise access, a reasoning engine 112, a semantic analyzer 114 and a rule generation engine 116. The reasoning engine 112, semantic analyzer 114 and rule generation engine 116 can be implemented as modules, services or plugins configured to perform various functions described herein. The version control repository 120, user merge rules repository 130, global merge rules repository 140 and inference repository 150 can be implemented, for example, using one or more suitable databases. The client device 160 can be a processing system, for example, a computer (e.g., a workstation, desktop computer, laptop computer, tablet computer, etc.), a smart phone, a network terminal, or any other device via which a user can interact with the version control system 110.

In one arrangement, the version control system 110, the version control repository 120, the user merge rules repository 130 and/or the inference repository 150 can be hosted by one or more servers to which the client device 160 is communicatively linked, for example via a communication network 170. In another arrangement, one or more of these components 110, 120, 130, 150 can be hosted by the client device 160. The global merge rules repository 140 can be communicatively linked to a plurality of user merge rules repositories, including the user merge rules repository 130, and the version control system 110 via the communication network 170.

The communication network 170 can be a medium used to provide communications links between the server(s) and/or client device 160 within the system 100. The communication network 170 may include connections, such as wire, wireless communication links, or fiber optic cables. The communication network 170 can be implemented as, or include, any of a variety of different communication technologies such as a WAN, a LAN, a wireless network, a mobile network, a Virtual Private Network (VPN), the Internet, the Public Switched Telephone Network (PSTN), or the like.

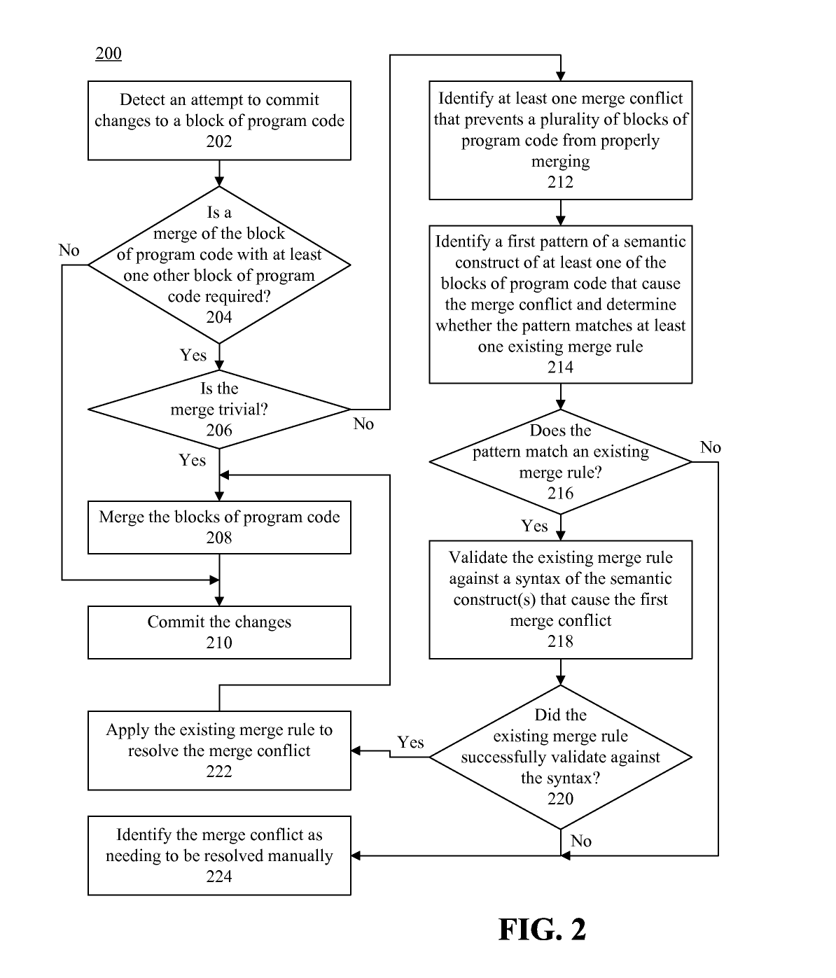

FIG. 2 is a flow chart illustrating an example of a method 200 of resolving merge conflicts arising from merging program code, for example using the system 100. In the following description, reference is made both to FIG. 1 and to FIG. 2.

At step 202, an attempt to commit changes to at least one block of program code 180 can be detected by the version control system 110. For example, an attempt by a user of the client device 160 to commit the changes can be detected. At decision box 204, the version control system 110 can determine whether a merge of the block 180 of program code with at least one other block 180 of program code is required. If not, the process can proceed to step 210 and the version control system 110 can commit the changes. If, however, a merge of the block 180 of program code with at least one other block 180 of program code is required, the process can proceed to decision box 206.

At decision box 206, the version control system 110 can determine whether the merge is trivial. The merge can be considered trivial if sections of syntax in the respective blocks 180 of program code that are common to the respective blocks 180 properly correlate. If the sections of syntax do not properly correlate, the merge can be determined to be non-trivial. In illustration, if each block 180 of program code includes a copyright notice, and the text of the copyright notice in the respective blocks 180 are not the same, the merge can be considered to be non-trivial. In another example, if each block 180 of program code includes an exception catch statement on corresponding lines of the program code, and the syntax of the exception catch statements in the respective blocks are not the same, the merge can be considered non-trivial. Still, numerous other examples of differences between blocks 180 of program code can be considered non-trivial, and the present arrangements are not limited in this regard.

If at decision box 206 the merge is considered to be trivial, at step 208 the version control system 110 can merge the respective blocks 180 of program code. The process then can proceed to step 210 and the version control system 110 can commit the changes to the block 180 of program code. If, however, at decision box 206 the merge is considered to be non-trivial, one or more merge conflicts may result from an attempt to merge the plurality of blocks 180 of program code. Accordingly, at step 212, the version control system 110 can execute or otherwise access the reasoning engine 112 to identify the merge conflict(s) that prevent the blocks 180 of program code from properly merging. The reasoning engine 112 then can take measures to attempt to resolve the merge conflict(s).

In illustration, in response to identifying a particular merge conflict, at step 212 the reasoning engine 112 can execute or otherwise access the semantic analyzer 114 to identify a pattern of a portion of program code, in at least one of the blocks 180 of program code being merged, which causes the merge conflict that prevents the plurality of blocks 180 of program code from properly being merged. Based on the pattern, the reasoning engine 112 can categorize the merge conflict. For instance, the reasoning engine 112 can store data identifying the merge conflict and a category assigned to the merge conflict. This data can be made available for review, included in one or more reports, etc.

Further, in response to identifying the particular merge conflict, the reasoning engine 112 can execute or otherwise access the semantic analyzer 114 to determine whether the pattern matches at least one existing merge rule, for example a merge rule contained in the user merge rules repository 130 or a merge rule contained in the global merge rules repository 140. At decision box 216, if the pattern does not match an existing merge rule, the process can proceed to step 224 and the reasoning engine 114 can identify the merge conflict as needing to be resolved manually. For example, at step 224 the reasoning engine 112 and/or another component of the version control system 110 can associate an identifier, which indicates manual intervention is required to resolve the merge conflict, with an identifier assigned to the merge conflict and the category assigned to the merge conflict. Further, the version control system 110 can identify a first block 180 of program code which the user is trying to commit and at least one other block with which the first block 180 needs to be merged once the merge conflict is resolved. This information can be provided to the user of the client device 160 in a suitable manner, stored, included in one or more reports, and/or the like.

If the pattern does match an existing merge rule, at step 218 the reasoning engine 112 can execute or otherwise access the semantic analyzer 114 to validate the existing merge rule against the syntax of the respective portions(s) of program code that cause the merge conflict. At decision box 220, the reasoning engine 112 can determine whether the existing merge rule successfully validates against the syntax. If the existing merge rule does not successfully validate against the syntax, the process can proceed to step 224 and the reasoning engine 112 can identify the merge conflict as needing to be resolved manually, for example as previously described.

If the existing merge rule does successfully validate against the syntax, the process can proceed to step 222 and the version control system 110 can apply the existing merge rule to resolve the merge conflict. For example, the version control system 110 can automatically update, in accordance with the existing merge rule, a first block 180 of program code containing the changes made by the user and/or automatically update a second block 180 of program code with which the first block 180 is being merged. Accordingly, the merge conflict can be resolved with little or no user intervention, thus saving time on part of the user that otherwise would be spent resolving the merge conflict before the blocks 180 of program code could be properly merged.

In one aspect, the version control system 110 can present the existing merge rule, as well as portions of the block(s) 180 of program code that will be affected by application of the existing merge rule, to the user before applying the existing merge rule. The user can be prompted to accept changes that will be made by application of the existing merge rule to the block(s) 180 of program code, or deny such changes. If the user denies the changes, the process can proceed to step 224 and the merge conflict can be identified as needing to be resolved manually.

Briefly referring again to step 212, if in step 212 more than one merge conflict is identified, steps 214 and appropriate ones of steps 218, 222, 224 (based on decisions made at decision box 216 and/or decision box 220) can be repeated for each additional merge conflict identified in step 212. If there is at least one merge conflict identified as needing to be resolved manually at step 224, even if one or more other merge conflicts have been successfully resolved by applying existing merge rules at step 222, then after each of the identified merge conflicts has been processed accordingly steps/decision boxes 214-222, the process can end. If, however, each of the merge conflicts identified at step 212 is resolved by applying existing merge rules, the process can proceed to step 208 and the version control system 110 can merge the blocks 180 of program code. The process further can proceed to step 210 and the version control system 110 can commit the changes made to the block 180 of program code. In response to the changes being successfully committed, the version control system 110 can notify the user that the changes were successful. The version control system 110 also can indicate any portions in the block(s) 160 of program code that were automatically updated by applying the existing merge rules. Optionally, the existing merge rules that were applied also can be indicated to the user.

Briefly referring again to step 222, in one arrangement, responsive to applying the existing merge rule to resolve the merge conflict, the version control system 110 can assign to the existing merge rule parameters relating to a weight and/or a level of relevance to the merge rule. If such parameters already are assigned to the existing merge rule, the version control system 110 can update the parameters. The weight and/or a level of relevance parameters can indicate a level of acceptance of the existing merge rule or a pattern of usage of the first existing merge rule. These parameters can be processed each time a merge rule is being considered for use in resolving a merge conflict to evaluate the likelihood that the merge rule being considered is the best candidate to use to attempt to resolve the merge conflict.

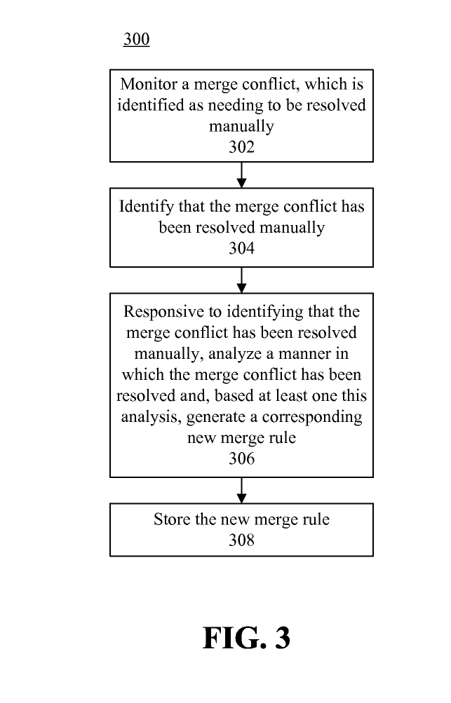

FIG. 3 is a flow chart illustrating an example of a method 300 of generating a new merge rule, for example using the system 100. In the following description, reference is made both to FIG. 1 and to FIG. 3.

If manual intervention on the part of a user is needed to resolve a merge conflict, at step 302 the version control system 110 can monitor the merge conflict. In illustration, the version control system 110 can communicate with the client device 160 to monitor changes the user makes to one or more blocks 180 of program code for which the merge conflict is identified at step 224 of FIG. 2. The version control system 110, for instance, can monitor changes the user makes to a portion of a first block 180 and/or a portion of a second block 180 with which the first block 180 is to be merged in order to resolve the merge conflict.

At step 304, the version control system 110 can identify that the merge conflict has been resolved when or after the user has manually resolved the merge conflict. At step 306, responsive to identifying the merge conflict being resolved manually, the rule generation engine 116 can analyze the manner in which the user resolved the merge conflict. Based at least on this analysis, the rule generation engine 116 can generate a corresponding new merge rule.

At step 308, the version control system 110 can store the new rule. For example, the version control system 110 can prompt the user to select whether to store the new merge rule in the user merge rules repository 130, store the new merge rule in the global merge rules repository 140, store the new merge rule elsewhere, or not store the merge rule. The version control system 110 can store or delete the new rule in accordance with the user's decision. For example, if the user chooses to store the new merge rule in the user merge rules repository 130, the rule will be available for future merge conflicts that arise when the user is attempting to merge blocks of program code. If the user chooses to store the new merge rule in the global merge rules repository 140, the rule can be made available for future merge conflicts that arise when any users of the system 100 are attempting to merge blocks of program code. In one aspect, the version control system 110 can synchronize the user merge rules repository 130 with the global merge rules repository 140, for example automatically or in response to a user request.

In one arrangement, the new merge rule can be stored in place of an existing merge rule. For example, if the version control system 110 determines that the new merge rule includes a resolution pattern that supersedes the resolution pattern of an existing merge rule, the version control system 110 can replace the existing merge rule with the new merge rule. In illustration, at step 222 of FIG. 2 an existing merge rule may have been presented to the user as an option to apply to resolve the merge conflict. If the user denied application of the existing merge rule to the merge conflict, and chooses to manually resolve the merge conflict, the version control system 110 can replace the existing merge rule with the new merge rule generated by analyzing the manner in which the user manually resolved the merge conflict.

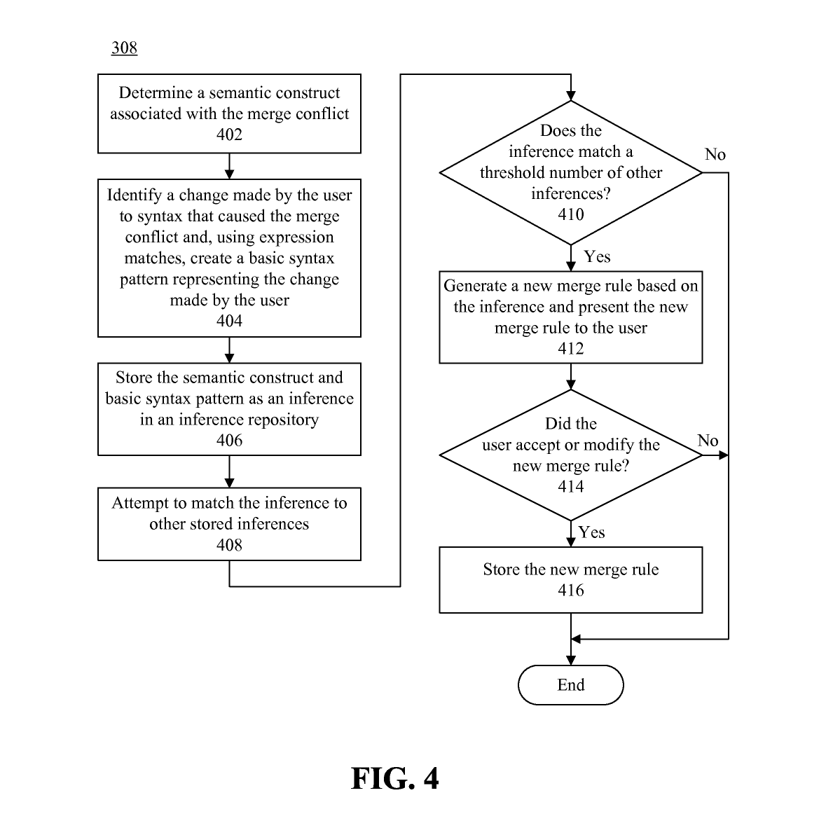

FIG. 4 is a flow chart illustrating a further example of a method of generating a new merge rule. Specifically, FIG. 4 illustrates an example of process that can be performed in step 308 of FIG. 3.

At step 402, the rule generation engine 116 can determine a semantic construct of the portion at least one of the blocks 180 of program code that cause the second merge conflict. At step 404, a change made by the user to syntax that caused the merge conflict can be identified by the rule generation engine 116 and, using expression matches, the rule generation engine 116 can generate a basic syntax pattern representing the change made by the user. At step 406, the rule generation engine 116 can store the semantic construct and basic syntax pattern as an inference, for example in the inference repository 150.

At step 408, the rule generation engine 116 can attempt to match the inference with other stored inferences. At decision box 410, the rule generation engine 116 can determine whether the inference matches a threshold number of other stored inferences. If not, the process can end. If, however, the inference matches a threshold number of other inferences, at step 412 the rule generation engine 116 can generate a new merge rule based on the inference and present the new merge rule to the user. At decision box 414, the rule generation engine 116 can determine whether the user accepts or modifies the new merge rule, for example based on user inputs detected by the client device 160. If the user accepts or modifies the new merge rule, at step 416 the rule generation engine 116 can store the new merge rule. In one arrangement, the rule generation engine 116 also can categorize the new merge rule. If the user does not accept or modify the new merge rule, the new merge rule is not stored and the process can end. In this case, optionally, the rule generation engine 116 can delete the inference from the inference repository 150.

The following is an example of generating a new merge rule. Assume a first block 180 of program code includes a copyright date of 2012. Also assume a second block 180 of program code includes a copyright date of 2013. When an attempt is made by a user to commit changes in one of these blocks 180, based on the copyright dates not matching, the version control repository 120 can identify a merge conflict. Assuming the merge conflict is not automatically resolved using an existing merge rule, the user can manually resolve the merge conflict, for example by changing the date 2012 to 2013.

In response to the merge conflict being manually resolved, the rule generation engine 116 can identify the resolution and form an inference of the resolution by performing the process described in FIG. 4. For example, the rule generation engine 116 can generate the following inference:
IN A BLOCK JAVADOC COMMENT
   (c) Copyright IBM Corporation 2009. All Rights Reserved. IS REPLACED BY
   (c) Copyright IBM Corporation 2013. All Rights Reserved.
      The rule generation engine 116 can store this inference in an inference repository 150. Further, the rule generation engine 116 can search the inference repository 150 to determine whether any similar inferences already are stored. If not, nothing further need be performed at this point.

Over time, similar merge conflicts may arise. Each time, the rule generation engine 116 can perform the above steps. When the rule generation engine 116 searches the inference repository 150 and determines that a threshold number (e.g., five) of similar inferences have been stored, the rule generation engine 116 can generate a new merge rule based on the inference. For example, through expression analysis and computation of text contained in the inference, the rule generation engine 116 can generate the following new merge rule:
Subject: Number
Context: Block Javadoc comment
Pattern: (c) Copyright (some text) subject some text
Rule: Accept contributor with higher value subject

When the user next connects to the version control system 110, the rule generation engine 116 can present the user with the above rule as a new merge rule. The user may accept the rule generated by the rule generation engine 116 as a new merge rule, in which case the user can store the new merge rule into the user merge rules repository 130 and/or the global merge rules repository 140, or the user may further modify the rule. For example, the user can modify the generated rule as follows:
Subject: Number
Context: Block Javadoc comment
Pattern: (c) Copyright (some text) subject some text
Rule: ACCEPT contributor with subject={SYSTEM_YEAR} ELSE
REJECT both contributors and set subject={SYSTEM_YEAR}
   The user then can store the above rule as a new merge rule in the user merge rules repository 130 and/or the global merge rules repository 140.

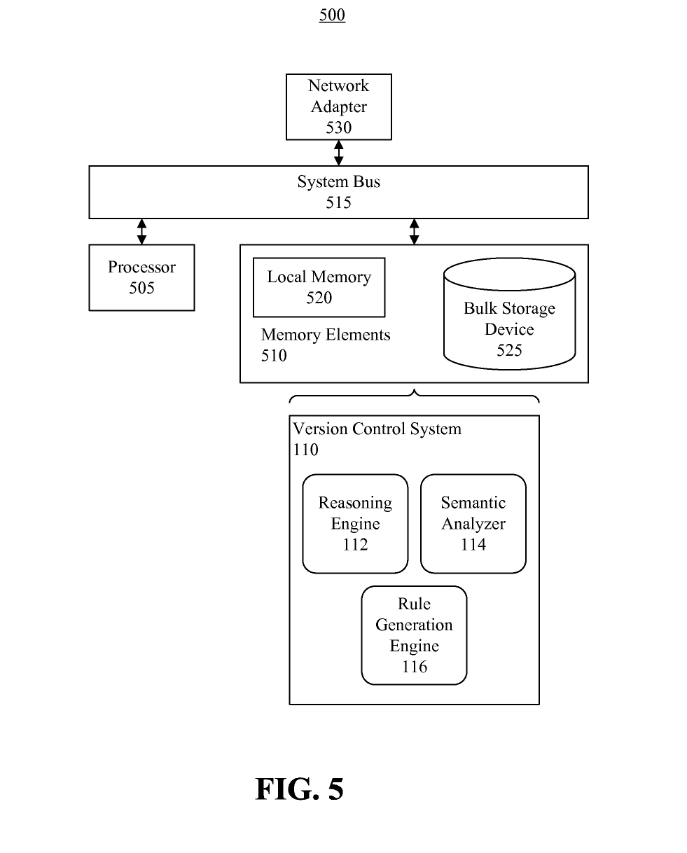

FIG. 5 is a block diagram illustrating example architecture for a data processing system (hereinafter “processing system”) 500 configured to host the version control system 110 of FIG. 1. The processing system 500 can include at least one processor 505 (e.g., a central processing unit) coupled to memory elements 510 through a system bus 515 or other suitable circuitry. As such, the processing system 500 can store program code within the memory elements 510. The processor 505 can execute the program code accessed from the memory elements 510 via the system bus 515. It should be appreciated that the processing system 500 can be implemented in the form of any system including a processor and memory that is capable of performing the functions and/or operations described within this specification. For example, the processing system 500 can be implemented as a server or a client device.

The memory elements 510 can include one or more physical memory devices such as, for example, local memory 520 and one or more bulk storage devices 525. Local memory 520 refers to RAM or other non-persistent memory device(s) generally used during actual execution of the program code. The bulk storage device(s) 525 can be implemented as a hard disk drive (HDD), solid state drive (SSD), or other persistent data storage device. The processing system 500 also can include one or more cache memories (not shown) that provide temporary storage of at least some program code in order to reduce the number of times program code must be retrieved from the bulk storage device 525 during execution.

One or more network adapters 530 can be coupled to processing system 500 to enable processing system 500 to become coupled to other systems, computer systems, remote printers, and/or remote storage devices through intervening private or public networks. Modems, cable modems, transceivers, and Ethernet cards are examples of different types of network adapters 530 that can be used with processing system 500.

As pictured in FIG. 5, the memory elements 510 can store the version control system 110 of FIG. 1, including the reasoning engine 112, the semantic analyzer 114 and the rule generation engine 116. Being implemented in the form of executable program code, these components 110-116 can be executed by the processing system 500 and, as such, can be considered part of the processing system 500. Moreover, the version control system 110, reasoning engine 112, semantic analyzer 114 and rule generation engine 116 are functional data structures that impart functionality when employed as part of the processing system 500 of FIG. 5.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-8. (canceled)

9. A system, comprising:
a processor programmed to initiate executable operations comprising:
identifying at least a first merge conflict that prevents a plurality of blocks of program code from properly being merged;
responsive to identifying the first merge conflict, identifying a first pattern of a respective portion of at least one of the blocks of program code that cause the first merge conflict and determining whether the first pattern matches at least a first existing merge rule;
responsive to determining that the first pattern matches the first existing merge rule, validating the first existing merge rule against a syntax of the portion of at least one of the blocks of program code that cause the first merge conflict; and
responsive to the first existing merge rule successfully validating against the syntax of the portion of at least one of the blocks of program code that cause the first merge conflict, applying the first existing merge rule to resolve the first merge conflict.

10. The system of claim 9, the executable operations further comprising:
responsive to identifying the first merge conflict, using the processor, categorizing the first merge conflict based on the first pattern; and
storing data identifying the first merge conflict and a category assigned to the first merge conflict.

11. The system of claim 9, the executable operations further comprising:
responsive to applying the first existing merge rule to resolve the first merge conflict, assigning to the first existing merge rule, or updating, at least one attribute selected from a group consisting a weight and a level of relevance, wherein the at least one attribute indicates a level of acceptance of the first existing merge rule or a pattern of usage of the first existing merge rule.

12. The system of claim 9, the executable operations further comprising:
identifying at least a second merge conflict that prevents the plurality of blocks of program code from properly being merged;
responsive to identifying the second merge conflict, using a processor, identifying a second pattern of a respective portion of at least one of the blocks of program code that cause the second merge conflict and determining whether the second pattern matches at least a second existing merge rule;
responsive to determining that the second pattern matches the second existing merge rule, validating the second existing merge rule against a syntax of the portion of at least one of the blocks of program code that cause the second merge conflict; and
responsive to the second existing merge rule not successfully validating against the syntax of the portion of at least one of the blocks of program code that cause the second merge conflict, identifying the second merge conflict as needing to be resolved manually.

13. The system of claim 12, the executable operations further comprising:
identifying that the second merge conflict has been resolved manually; and
responsive to identifying that the second merge conflict has been resolved manually, analyzing a manner in which the second merge conflict has been resolved and, based at least on the analysis, generating a new merge rule.

14. The system of claim 13, wherein:
analyzing the manner in which the second merge conflict has been resolved comprises:
identifying a change made by a user to the portion of at least one of the blocks of program code that cause the second merge conflict; and
generating the new merge rule comprises:
determining a semantic construct of the portion at least one of the blocks of program code that cause the second merge conflict;
using expression matches, creating a basic syntax pattern representing the change made by the user;
creating an inference comprising the semantic construct and the basic syntax pattern representing the change made by the user;
generating the new merge rule based on the inference; and
storing the new merge rule.

15. The system of claim 14, wherein:
generating the new merge rule based on the inference further comprises:
attempting to match the inference to other stored inferences;
determining whether the inference matches a threshold number of other inferences; and
responsive to determining that the inference matches a threshold number of other inferences, presenting the new merge rule to the user;
wherein storing the new merge rule is responsive to the user accepting or modifying the new merge rule.

16. The system of claim 13, the executable operations further comprising:
categorizing the new merge rule.

17. A computer program product comprising a computer readable storage medium having program code stored thereon, the program code executable by a processor to perform a method comprising:
identifying, using the processor, at least a first merge conflict that prevents a plurality of blocks of program code from properly being merged;
responsive to identifying the first merge conflict, using the processor, identifying a first pattern of a respective portion of at least one of the blocks of program code that cause the first merge conflict and determining whether the first pattern matches at least a first existing merge rule;
responsive to determining that the first pattern matches the first existing merge rule, validating, using the processor, the first existing merge rule against a syntax of the portion of at least one of the blocks of program code that cause the first merge conflict; and
responsive to the first existing merge rule successfully validating against the syntax of the portion of at least one of the blocks of program code that cause the first merge conflict, applying, using the processor, the first existing merge rule to resolve the first merge conflict.

18. The computer program product of claim 17, the method further comprising:
responsive to identifying the first merge conflict, using the processor, assigning a the first merge conflict to a category based on the first pattern; and
storing data identifying the first merge conflict and the category to which the first merge conflict is assigned.

19. The computer program product of claim 17, the method further comprising:
responsive to applying the first existing merge rule to resolve the first merge conflict, assigning to the first existing merge rule, or updating, at least one attribute selected from a group consisting a weight and a level of relevance, wherein the at least one attribute indicates a level of acceptance of the first existing merge rule or a pattern of usage of the first existing merge rule.

20. The computer program product of claim 17, the method further comprising:
identifying, using the processor, at least a second merge conflict that prevents the plurality of blocks of program code from properly being merged;
responsive to identifying the second merge conflict, using a processor, identifying, using the processor, a second pattern of a respective portion of at least one of the blocks of program code that cause the second merge conflict and determining whether the second pattern matches at least a second existing merge rule;
responsive to determining that the second pattern matches the second existing merge rule, validating, using the processor, the second existing merge rule against a syntax of the portion of at least one of the blocks of program code that cause the second merge conflict; and
responsive to the second existing merge rule not successfully validating against the syntax of the portion of at least one of the blocks of program code that cause the second merge conflict, identifying, using the processor, the second merge conflict as needing to be resolved manually.

21. The computer program product of claim 20, the method further comprising:
identifying, using the processor, that the second merge conflict has been resolved manually; and
responsive to identifying that the second merge conflict has been resolved manually, analyzing, using the processor, a manner in which the second merge conflict has been resolved and, based at least on the analysis, generating a new merge rule.

22. The computer program product of claim 21, wherein:
analyzing the manner in which the second merge conflict has been resolved comprises:
identifying a change made by a user to the portion of at least one of the blocks of program code that cause the second merge conflict; and
generating the new merge rule comprises:
determining a semantic construct of the portion at least one of the blocks of program code that cause the second merge conflict;
using expression matches, creating a basic syntax pattern representing the change made by the user;
creating an inference comprising the semantic construct and the basic syntax pattern representing the change made by the user;
generating the new merge rule based on the inference; and
storing the new merge rule.

23. The computer program product of claim 22, wherein:
generating the new merge rule based on the inference further comprises:
attempting to match the inference to other stored inferences;
determining whether the inference matches a threshold number of other inferences; and
responsive to determining that the inference matches a threshold number of other inferences, presenting the new merge rule to the user;
wherein storing the new merge rule is responsive to the user accepting or modifying the new merge rule.

24. The computer program product of claim 21, the method further comprising:
assigning the new merge rule to a category.
